(19) United States
(12) Patent Application Publication
(10) Pub. No.: US 2024/0391129 A1
(43) Pub. Date: Nov. 28, 2024

(54) DIAMOND SEGMENT WITH WELD PAD

(71) Applicant: Oregon Tool, Inc., Portland, OR (US)

(72) Inventor: Todd Gerlach, Tualatin, OR (US)

(21) Appl. No.: 18/670,463

(22) Filed: May 21, 2024

Related U.S. Application Data
(60) Provisional application No. 63/468,378, filed on May 23, 2023.

(51) Int. Cl. B27B 33/14; B21D 22/02

(52) U.S. Cl. CPC B27B 33/142; B21D 22/02

(57) ABSTRACT

A diamond segment may include a steel weld pad that is configured to be coupled with a drive link of a cutting chain. The diamond segment may further include a diamond layer that is coupled with the steel weld pad such that the diamond layer extends along a height of the steel weld pad at a peripheral portion of the steel weld pad. Other embodiments may be described and claimed.

### CROSS-REFERENCE TO RELATED APPLICATION

This application claims priority to and the benefit of U.S. Provisional Patent Application No. 63/468,378, filed May 23, 2023, the entire disclosure of which is incorporated by reference herein in its entirety.

### FIELD

Embodiments of the present invention relate generally to the technical field of cutting implements, and more particularly to a chain link that includes a diamond segment with a weld pad.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

A cutting apparatus, for example a chainsaw, may utilize a chain formed of a plurality of links. Each link may have a cutting element. Generally, it may be desirable for the cutting elements to have a strength capable of withstanding the cutting application or a sudden stop without damage to the cutting element.

Legacy chains, for example those utilizing conventional diamond segments that involve a cutting element that at least partially includes diamond material, may be limited because they may require the diamond layer to provide both adequate strength and acceptable cutting performance. Such limitations may constrain the ability to develop diamond layer formulations that allow for faster cuts with less damage to the cutting elements.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example weld pad, in accordance with some embodiments.

FIG. 2 illustrates an example of a weld pad and a sintered diamond layer, in accordance with some embodiments.

FIG. 3 illustrates an example of a weld pad, a sintered diamond layer, and a drive link, in accordance with some embodiments.

FIG. 4 illustrates an example of a chain link that includes a weld pad, a sintered diamond layer, and a drive link, in accordance with some embodiments.

FIGS. 5A, 5B, and 5C (collectively, “FIG. 5”) illustrate various views of the chain link of FIG. 4, in accordance with some embodiments.

FIGS. 6A, 6B, 6C, 6D, and 6E (collectively, “FIG. 6”) illustrate an alternative example chain link, in accordance with some embodiments.

FIG. 7 illustrates an alternative example chain link, in accordance with some embodiments.

FIG. 8 illustrates an example technique for manufacturing the chain link of FIG. 4, in accordance with some embodiments.

FIG. 9 illustrates an alternative example technique for manufacturing the chain link of FIG. 4, in accordance with some embodiments.

FIG. 10 illustrates another chain link, in accordance with some embodiments.

FIG. 11 illustrates a diamond layer and a weld pad for a chain link, in accordance with some embodiments.

FIG. 12 illustrates another diamond layer and another weld pad for a chain link, in accordance with some embodiments.

FIG. 13 illustrates another diamond layer and another weld pad for a chain link, in accordance with some embodiments.

FIG. 14 illustrates another diamond layer and another weld pad for a chain link, in accordance with some embodiments.

FIG. 15 illustrates a chain link having a diamond layer and weld pad, in accordance with some embodiments.

FIG. 16 illustrates the diamond layer and weld pad of FIG. 15, in accordance with some embodiments.

FIG. 17 illustrates another diamond layer and another weld pad for a chain link, in accordance with some embodiments.

FIG. 18 illustrates another diamond layer and another weld pad for a chain link, in accordance with some embodiments.

FIG. 19 illustrates another diamond layer and another weld pad for a chain link, in accordance with some embodiments.

FIG. 20 illustrates another chain link, in accordance with some embodiments.

FIG. 21 illustrates another view of the chain link of FIG. 20, in accordance with some embodiments.

FIG. 22 illustrates additional views of the chain link of FIG. 20, in accordance with some embodiments.

FIG. 23 illustrates a tie strap and diamond layer, in accordance with some embodiments.

FIG. 24 illustrates another tie strap and diamond layer, in accordance with some embodiments.

FIG. 25 illustrates another view of the tie strap and diamond layer of FIG. 23, in accordance with some embodiments.

FIG. 26 illustrates another view of the tie strap and diamond layer of FIG. 24, in accordance with some embodiments.

FIG. 27 illustrates a cutting chain including the tie straps and diamond layers of FIGS. 23-26, in accordance with some embodiments.

FIG. 28 illustrates another tie strap and another diamond layer, in accordance with some embodiments.

FIG. 29 illustrates another tie strap and another diamond layer, in accordance with some embodiments.

FIG. 30 illustrates a cutting chain include the tie straps and diamond layers of FIGS. 28-29, according to some embodiments.

FIG. 31 illustrates additional views of the cutting chain of FIG. 30, according to some embodiments.

### DETAILED DESCRIPTION

In the following detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “substantially,” “close,” “approximately,” “near,” and “about,” generally refer to being within +/− 10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, the term “coupled” means the joining of two members or elements directly or indirectly to one another. Such joining may be stationary or moveable in nature. Such joining may be achieved with the two members or the two members and any additional intermediate members being formed integrally as a single unitary body with one another or with the two members or the two members and any additional intermediate members being attached to one another, directly or indirectly. Such joining may be permanent in nature or may be removable or releasable in nature.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As previously discussed, legacy chains, for example those utilizing conventional diamond segments that involve a cutting element that at least partially includes diamond material, may be limited because they may require the diamond layer to provide both adequate strength and acceptable cutting performance. Such limitations may constrain the ability to develop diamond layer formulations that allow for faster cuts or longer cutting life with less damage to the cutting elements.

Embodiments herein relate to a chain that includes diamond-based chain links. Specifically, the chain links may include a diamond segment. The diamond segment may be formed of a sintered diamond layer that is coupled with a weld pad. Such a diamond segment may be referred to as a “laminated” diamond segment. The diamond segment may be a mixture of diamond-impregnated metal powder (e.g., a “diamond layer”) that is sintered and adhered to a thin metal-alloy strip (e.g., a weld pad). The diamond layer may serve as the working interface to abrade hard materials such as concrete, stone, and metals. The weld pad may serve as a load-bearing member and interfacing element to join the laminated diamond segment to a chain chassis element (e.g., a drive link) using conventional joining techniques such as laser welding or some other type of welding.

Generally, embodiments may have one or more of the following characteristics. A first characteristic may be that the weld pad extends at least the full length and width of the diamond layer. Another characteristic may be that areas of the weld pad periphery are relieved vertically through the full thickness of the weld pad. The diamond layer may then extend to the bottom surface of the weld pad. This may create an interlocking geometry that resists cutting and impact loads applied in the long axis direction of the segment (e.g., in a direction along which the chain link will move). This characteristic may also allow for defined areas of the diamond layer to be coplanar with the top of the drive link of the chain, without interfering with welding of the weld pad to the drive link, thereby improving stability and reducing chassis wear.

In another characteristic, the weld pad may resist contact wear and upward forces from the tie straps. Specifically, the top profile of adjacent tie straps may make contact with the underside of the weld pad when the chain is under a cutting load. Additionally, when the chain is subject to a rapid stoppage event (i.e., a “chain snag”), the chain joints may reverse articulate. This reverse articulation may generate a substantial upward “prying” force on the underside of the weld pad by the tie straps. With conventional diamond segments, this prying force may cause segment breakage. By contrast, embodiments herein may mitigate this failure mode.

In addition, the weld pad or diamond segments described herein may carry cutting and impact loads. Specifically, the steel-to-steel interface of the weld pad and the tie strap may reduce wear and maintain greater chain stability throughout the life of the chain. Additionally, the weld pad may support the diamond layer in multiple load directions.

Embodiments may introduce a number of advantages. For example, by sintering the diamond layer, the mechanical strength of the diamond layer may be enhanced without influencing the cutting performance of the diamond layer. Additionally, the use of the weld pad described herein may increase the mechanical stability of the chain link. Additionally, by providing both the weld pad and the diamond layer, the chain link may allow for improved chain stability and cutting efficiency.

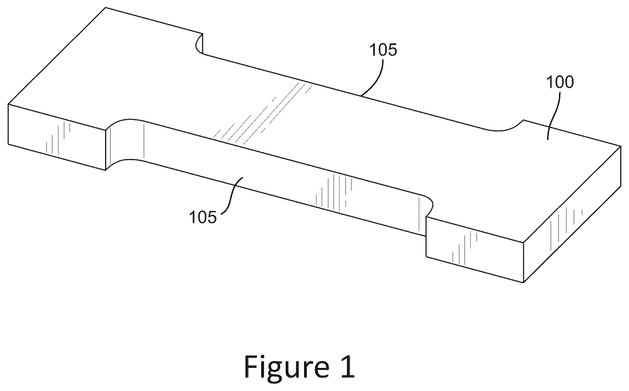

FIG. 1 illustrates an example weld pad 100, in accordance with embodiments herein. Generally, the weld pad 100 may be considered to be a steel weld pad. Specifically, the weld pad 100 may be formed of a material such as low-carbon steel (which may also be referred to as American Iron and Steel Institute (AISI) 1010, or equivalents). In some embodiments, the weld pad 100 is coated with diamonds on one or more sides of the weld pad 100. Additionally, as may be seen, the weld pad 100 may have a recess portion 105 that extends through the entirety of the weld pad 100. The recess portion 105 may be present on one or both sides of the weld pad 100. In some embodiments, if the recess portion 105 is on both sides of the weld pad 100, the recess portion 105 may have the same shape on both sides (that is, the weld pad 100 may be symmetrical). In other embodiments, if the recess portion 105 is on both sides of the weld pad 100, the recess portion 105 may have a different shape on one side of the weld pad 100 than the other side (that is, the weld pad 100 may be asymmetric). In other embodiments, a weld pad 100 may have a plurality of recess portions on one side of the weld pad 100. That is, the periphery of the weld pad 100 may have a sawtooth-type profile, a wave-type profile, or some other pattern.

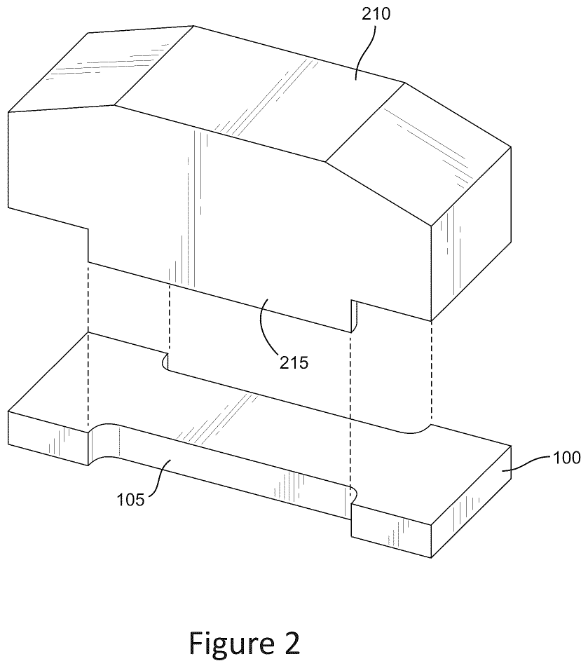

FIG. 2 illustrates an example of a weld pad 100 and a sintered diamond layer 210, in accordance with embodiments herein. The sintered diamond layer 210 may be formed of diamond and a matrix material such as one or more of cobalt, nickel, iron, zinc, copper, tin, phosphorous, aluminum, manganese, chromium, etc. One or more of these materials may be included in an elemental form or as alloys.

Generally, the materials may then be “sintered.” As used herein, “sintered” refers to a technique of manufacture wherein the materials are subjected to heat and pressure to form a unitary element without liquefaction of the materials. It will be understood, however, that in other embodiments the diamond layer 210 may be formed through a different technique and process.

Advantageously, the structural advantages of the weld pad 100 in combination with the sintered diamond layer 210 (e.g., mechanical and chemical interfaces therebetween), for example as described below, can enable cobalt to be omitted from the sintered diamond layer 210 (e.g., in favor of other matrix material such as nickel or iron) and from chain links, chains, etc. according to the teachings herein, which can be advantageous for environmental or other reasons relating to cobalt supply and usage. In some embodiments, iron is the matrix material, which can provide an improved bond to steel of the weld pad 100 as compared to other matrix materials. In various embodiments, different matrix materials, combinations, formulations, etc. are used for the sintered diamond layer 210 which provide different hardness, wear rate, etc. for the sintered diamond layer 210 once sintered. The structural advantages of the weld pad 100 in combination with the sintered diamond layer 210 herein can enable a wider variety of formulations to be used in various embodiments (as compared to conventional approaches), thereby enabling tuning of overall chain performance by selection of formulation of the materials forming the sintered diamond layer 210.

In some embodiments, the diamond layer 210 is formed as a segment having multiple layers (e.g., layers of different matrix material). For example, the diamond layer 210 may include a first sintered diamond portion having first characteristics (e.g., a first hardness, a first wear rate, a first matrix material, etc.) and a second sintered diamond portion having second characteristics (e.g., a second hardness, a second wear rate, a second matric material, etc.). In some embodiments, an outer portion of the diamond layer 210 is configured to facilitate initial use of the cutting chain including such diamond layers, for example by providing a soft outer layer which is quickly opened to expose diamond upon first use of the cutting chain, while an inner portion of the diamond layer 210 is configured for long-time use (e.g., formulated to be harder, more durable, etc.). A multi-layered diamond layer (segment) according to such embodiments can be formed in a single, unified sintering process.

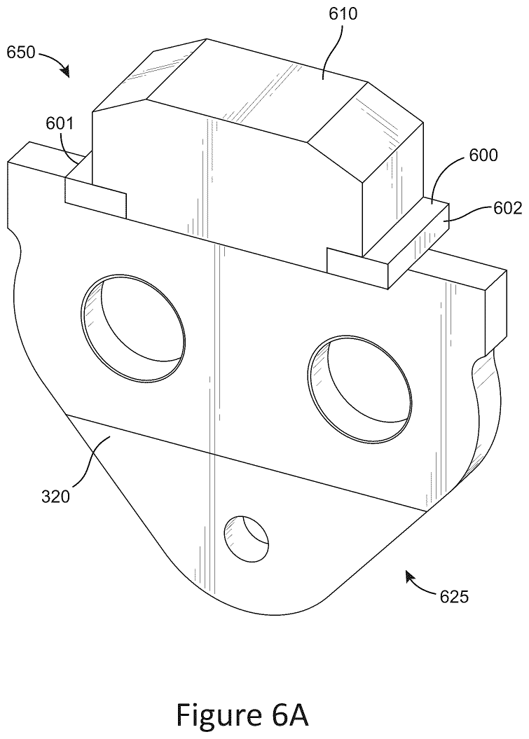

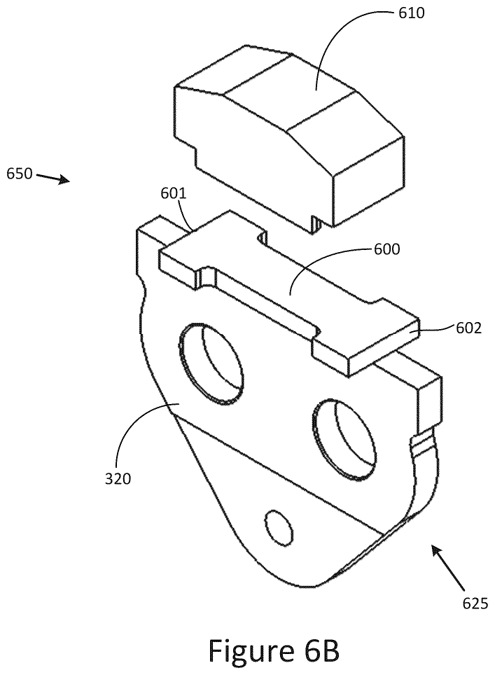

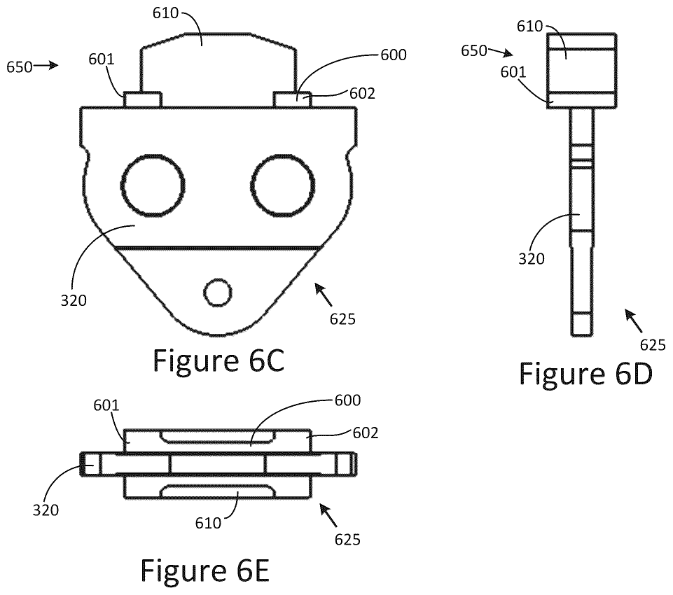

As may be seen, the sintered diamond layer 210 may have one or more protrusions 215. The protrusion 215 may align with the recess portion 105 of the weld pad 100. In this way, the protrusion 215 and the recess portion 105 may serve to further mechanically couple the weld pad 100 and the diamond layer 210 such that the recess portion 105 may “catch” the sintered diamond layer 210 to move the sintered diamond layer 210 in conjunction with the weld pad 100. As shown, the weld pad 100 is coextensive with an underside of the sintered diamond layer, except for inclusions of the recess portions 105 corresponding to the protrusions 215. In other embodiments, the weld pad 100 extends beyond the diamond pad (e.g., providing a surface area larger than the underside of the sintered diamond layer (e.g., longer, wider, as in FIG. 6, etc.).

Generally, as may be seen in FIG. 2, and other Figures herein, the recess portions 105 and the protrusions 215 may be located at a periphery of the weld pad 100 and the diamond layer 210. Such a configuration may offer several benefits. One such benefit may be that the diamond layer 210, which may serve as the cutting material, is located at the periphery of the overall chain link. As such, the diamond layer 210 may provide an increased cutting surface, including a lateral cutting surface provided by the protrusion 215. Additionally a portion of the weld pad 100 that contacts the kerf walls of the cut may inhibit cutting due to added friction and heat (i.e., “drag”). As such, minimizing such inhibiting material may serve to improve overall cutting efficiency. Also, with the diamond layer 210 extending the full height of the segment, abrasive erosion on the lateral cutting surface may be reduced, and overall segment width may be more consistently maintained through the life of the chain. This consistency may result in improved diamond life, as the segment will predominately wear in a desired vertical (i.e., top down) fashion.

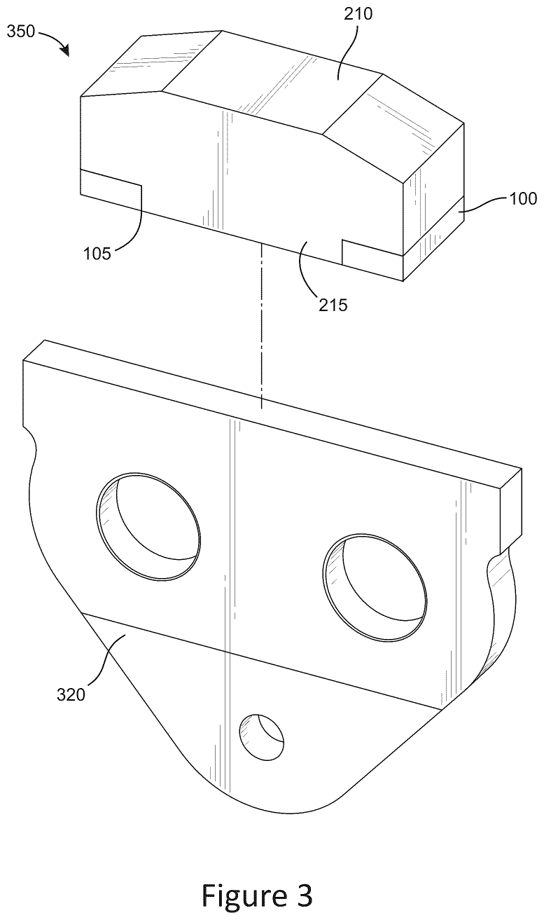

FIG. 3 illustrates an example of a weld pad 100, a sintered diamond layer 210, and a drive link 320, in accordance with embodiments herein. As may be seen, the weld pad 100 may be coupled with the sintered diamond layer 210 to form a diamond segment 350. The protrusion 215 may be positioned in the recess portion 105 as shown. It will be noted that the protrusion 215 may extend through the entirety of the recess portion 105, but is not depicted to extend beyond the weld pad 100. This configuration may be to prevent the protrusion 215 from interfering with coupling of the weld pad 100 to drive link 320.

Drive link 320 may be a linkage of a chain as described above. Drive link 320 may be formed of a steel material similar to that of weld pad 100, or may be formed of a different material. The weld pad 100 may be coupled with the drive link 320 through welding (e.g., laser welding) or some other coupling/joining technique. Because the protrusions 215 of the diamond layer 210 are shown as extending at least across a thickness of the weld pad 100, the protrusions 215 may at least partial protect, shield, etc. the weld or other coupling between the weld pad 100 and the drive link 320 from the environment during use, thereby reducing wear on the underside of the weld pad 100 and on the coupling between the weld pad 100 and the drive link 320.

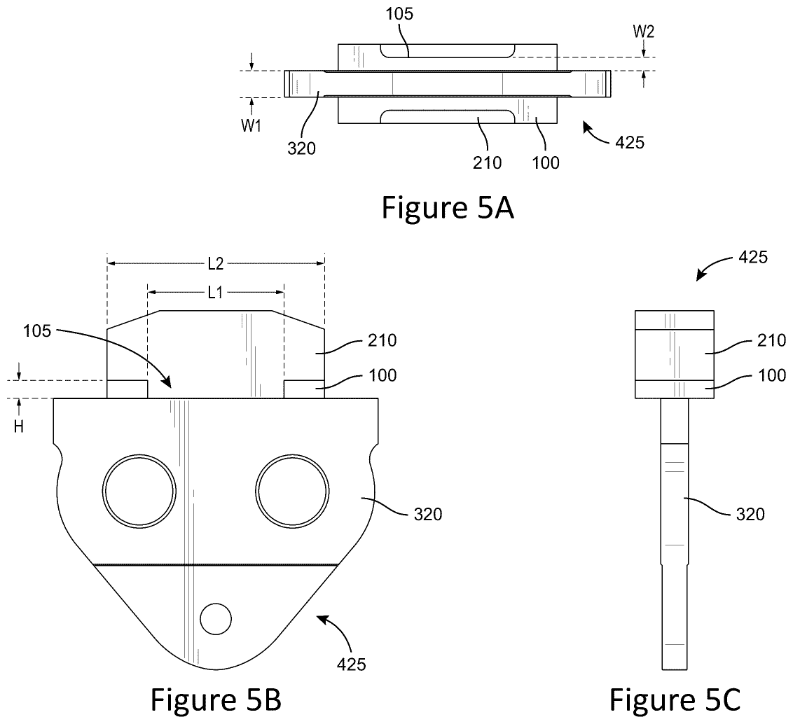

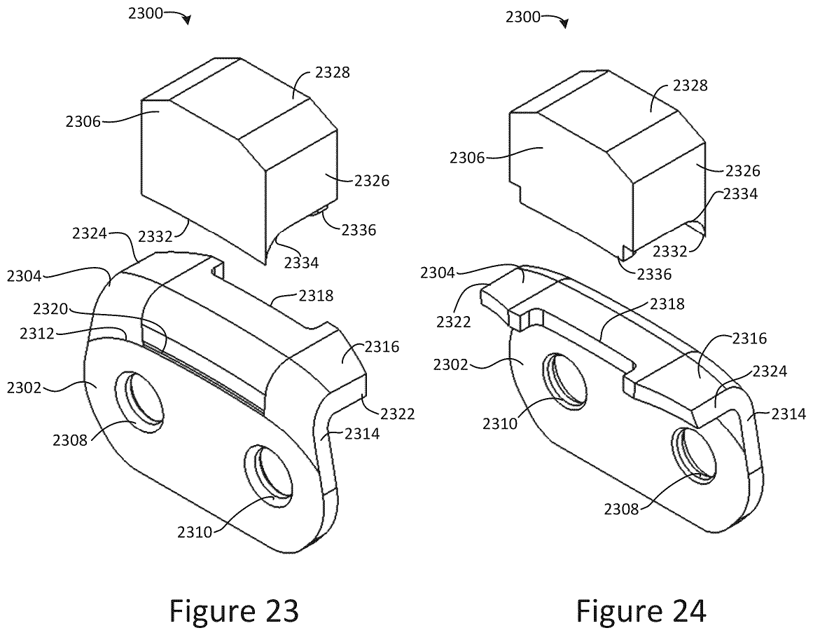

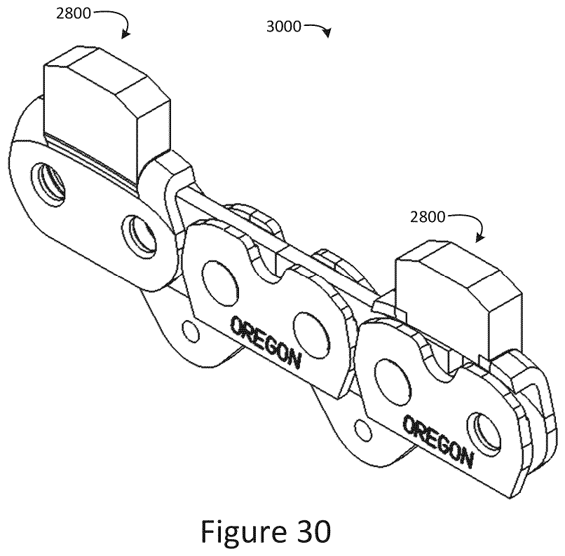

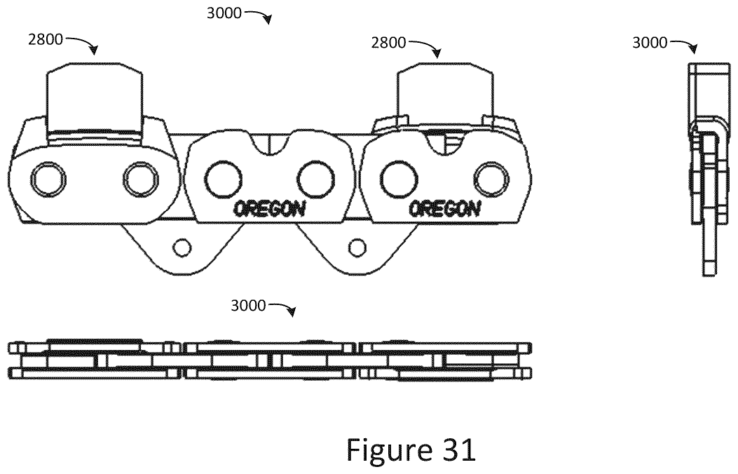

In some embodiments, the weld pad 100 and the drive link 320 (or, in other embodiments, a tie strap as described with reference to FIGS. 23-31 below) are formed together as a unitary structure (e.g., stamped, etc. as a single piece) such that the diamond layer 210 is joined directly to the unitary structure, thereby eliminating a manufacturing step of coupling the weld pad 100 with the drive link 320 and reducing the number of individual parts in a chain as compared to other embodiments. In some such embodiments, the drive link 320 and the weld pad 100 form an L-shape from an end view (rather than a T-shape as from the perspective shown in FIG. 5C described below), which can facilitate formation as a unitary structure. A cutting chain may include L-shapes pointing two directions, i.e., a left and right version of the cutting link, for example alternating along a length of the chain.

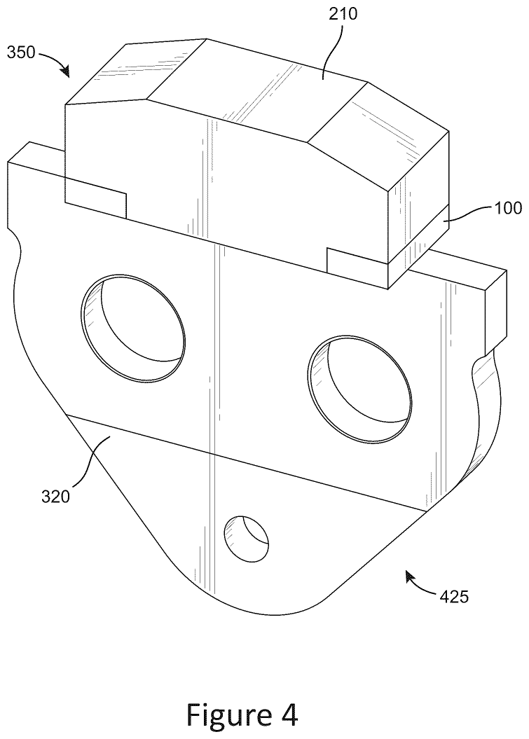

FIG. 4 illustrates an example of a chain link 425 that includes the weld pad 100, sintered diamond layer 210, and drive link 320 after the weld pad 100 is coupled with the drive link 320, in accordance with embodiments herein. In some embodiments, the chain link 425 may additionally or alternatively be referred to as a “drive link cutter.”

FIGS. 5A, 5B, and 5C (collectively, “FIG. 5”) illustrate various views of the chain link 425 of FIG. 4, in accordance with embodiments herein. Specifically, FIG. 5A depicts a view from the bottom of the chain link 425. FIG. 5B shows a view from the side of the chain link, which may be generally perpendicular to the direction of travel of the chain link 425 during operation. FIG. 5C shows a view of the chain link 425 aligned with the axis of travel of the chain link. Generally, the views may show relative dimensions and orientations of various elements such as the weld pad 100, sintered diamond layer 210, and drive link 320.

Generally, the various dimensions depicted in FIG. 5 may be viewed as relative to the width W1 of the drive link 320. In some embodiments, W1 may be between approximately .040 inches and approximately .080 inches. The distance W2 along the width of the weld pad 100 as measured from the drive link 320 to the recess portion 105 may be greater than or equal to approximately 40% of W1. The weld pad 100 may have a height H that is between approximately 35% and approximately 70% of W1. The recess portion 105 may have a length L1 that is at least 50% of the total length L2 of the weld pad 100. It will be noted that these dimensions are intended as example dimensions of one embodiment, and other embodiments may have different dimensions based on factors such as the material used in the weld pad 100 or the sintered diamond layer 210, the type of weld used to attach the weld pad 100 to the drive link 320, or other factors. Advantageously, the teachings herein can enable narrower drive links 320 as compared to other implementations, for example due to increased weld area and strength between the drive link 320 and the weld pad 100 as compared to other approaches (e.g., approaches where the drive link 320 is welded to a sintered weld layer). Narrower cutting chains enabled by the present disclosure can increase cutting efficiency (e.g., reduce required power, increase cutting speed).

Various aspects of the chain link 425 may be observed in FIG. 5. For example, in FIGS. 5A and 5C it may be observed that the sintered diamond layer 210 is coplanar with the underside of weld pad 100 at the recess portion 105 (e.g., the sintered diamond layer 210 does not extend below the height H of the weld pad 100). Additionally, as may be seen in FIG. 5B, at least portions of the drive link 320 may be directly coupled with the weld pad 100 as described above.

FIGS. 6A-E (collectively, “FIG. 6”) illustrate an alternative example chain link 625, in accordance with embodiments herein and from various perspectives and views. Specifically, FIG. 6 depicts a chain link 625 with a diamond segment 650 formed of a weld pad 600 (which may be similar to weld pad 100) that extends beyond the sintered diamond layer 610 (which may be similar to sintered diamond layer 210) in at least one dimension. In particular, as shown in FIG. 6, opposing longitudinal ends 601, 602 of the weld pad 600 extend beyond the diamond segment 650 such that the weld pad 600 has a greater length than the diamond segment 650 (i.e., in an intended direction of movement of the chain link 625 when in use).

Such a configuration may provide various advantages. One such advantage may be that a shorter diamond layer 610, with respect to the weld pad 600, may reduce the contact area in the cut and increase unit loading between the diamonds and the workpiece, which in turn may promote a more aggressive cut interface engagement. The teachings herein enable the dimensions of the diamond layer 610 to be adjusted to provide different performance characteristics for a cutting chain, as may be desirable for different use cases or different user preferences. Secondly, the length of the weld pad 600 may be defined based on the desired weld strength, which in turn is proportional to weld area. Providing appropriate “reach” (e.g., length of the weld pad is sufficient to extend to or beyond the upper profile of the tie straps) may ensure contact and support of the upper profile of the adjacent tic straps (not shown) under cutting loads and other applied loads described above.

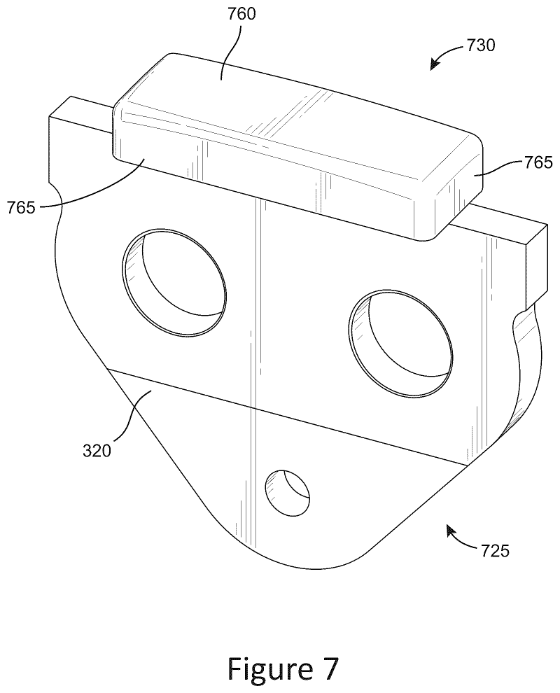

FIG. 7 illustrates an alternative or additional example chain link 725, in accordance with embodiments herein. In some embodiments, a cutting chain includes the chain link 725 and the chain link 425, for example such that the cutting chain alternates between instances of chain link 725 and chain link 425 along the cutting chain. In the chain link 725 as shown in FIG. 7, rather than using a sintered diamond layer (e.g., sintered diamond layer 210), the weld pad itself (not shown by itself in FIG. 7) may have a contoured geometry to which a single-layer diamond coating is applied to encapsulate the weld pad and form the diamond-covered weld pad 730. Specifically, the single-layer diamond-coating may cover both a cutting face 760 of the weld pad, as well as a periphery 765 of the weld pad, as shown. Generally, the coating may be the result of brazing diamond and a nickel-alloy powder. The resultant coating may bond a single-layer of diamonds (referred to with respect to this embodiment as the “diamond layer”) directly to the weld pad.

In some embodiments, the weld pad of FIG. 7 may be similar to weld pad 100 or 600. In other embodiments, the weld pad of FIG. 7 may have a different shape, size, or contour than the weld pads 100 or 600. For example, in some embodiments the weld pad of FIG. 7 may have contoured corners, which may increase the cutting surface or efficiency of the resultant chain link 725. Other embodiments may similarly vary and include, for example, a serrated-type profile in one or more dimensions, a wave-like or squared-off profile in one or more dimensions, a rounded profile, etc.

As noted above, the formation of the diamond layer, and subsequent bonding to the weld pad, may include a brazing process rather than, e.g., the sintering process described above that is used to bond sintered diamond layer 210 to weld pad 100. As used herein, a “brazing process” may refer to a process whereby temperature is used to join the two elements, without the inclusion of the pressure component which may be typical of a sintering process. The resultant chain link 725 may be desirable in applications that include generally non-abrasive cut media such as iron, ductile iron, polyvinyl chloride (PVC), high density polyethylene (HDPE), etc., particularly when such media is in the form of a pipe.

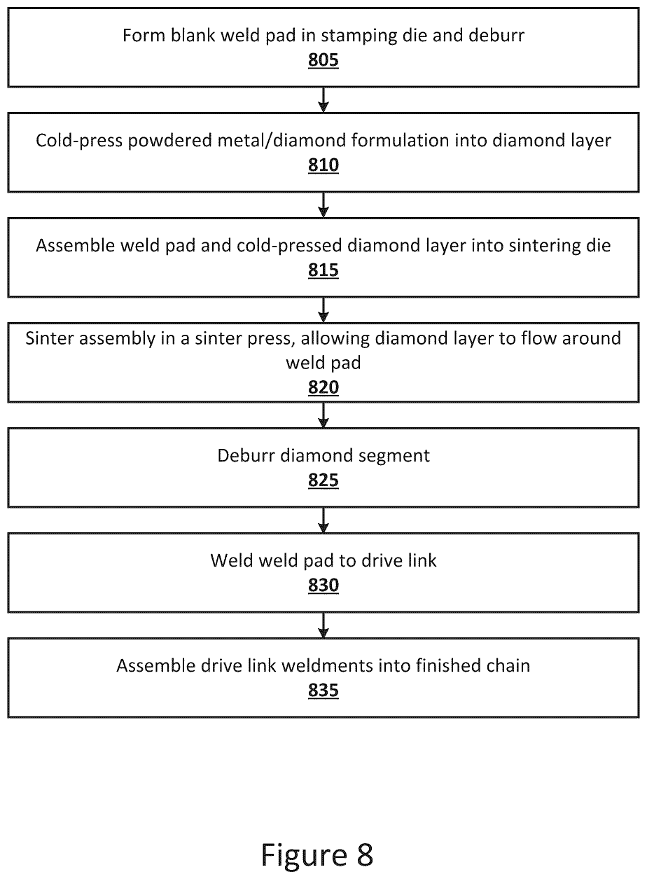

FIG. 8 illustrates an example technique 800 for manufacturing the chain link 425 of FIG. 4 (or some other chain link herein), in accordance with embodiments herein. The technique may include forming, at 805, a blank weld pad (e.g., weld pad 100) in a stamping die, and then performing a deburring process to ensure that the weld pad 100 is acceptably smooth and blemish free.

The technique may further include cold-pressing, at 810, the powdered metal/diamond formulation described above with respect to sintered diamond layer 210 into a diamond layer. Generally, cold-pressing may refer to a technique by which the powdered metal/diamond formulation is compressed into a semi-structurally sound solid that can be manipulated.

The technique may further include assembling, at 815, the weld pad from element 805 and the cold-pressed diamond layer from element 810 into a sintering die. The technique may then include sintering, at 820, the assembly from element 815 in a sinter press. As described above, sintering may refer to the application of heat and pressure to an assembly without liquefying the assembly. The sintering may accomplish multiple objectives. A first objective may be that the sintering may harden the cold-pressed diamond layer into a sintered diamond layer (e.g., element 210) with acceptable strength and hardness properties. Additionally, the sintering process may accomplish a second objective of joining the sintered diamond layer to the weld pad. Finally, the sintering process may cause the cold-pressed diamond layer to reform and flow around the weld pad in a controlled manner such that protrusions 215 may form in recess portions 105 of the weld pad 100.

The resultant sintered diamond segment (which may be similar to diamond segment 325 or some other diamond segment described herein) may then be deburred at 825, and the weld pad/diamond layer assembly may be welded to a drive link (e.g., drive link 320) at 830. As described above, such welding may be laser welding or some other form of welding or coupling. This process may be repeated to produce multiple drive links that are assembled, at 835, into a finished chain for use in a chainsaw or other cutting implement.

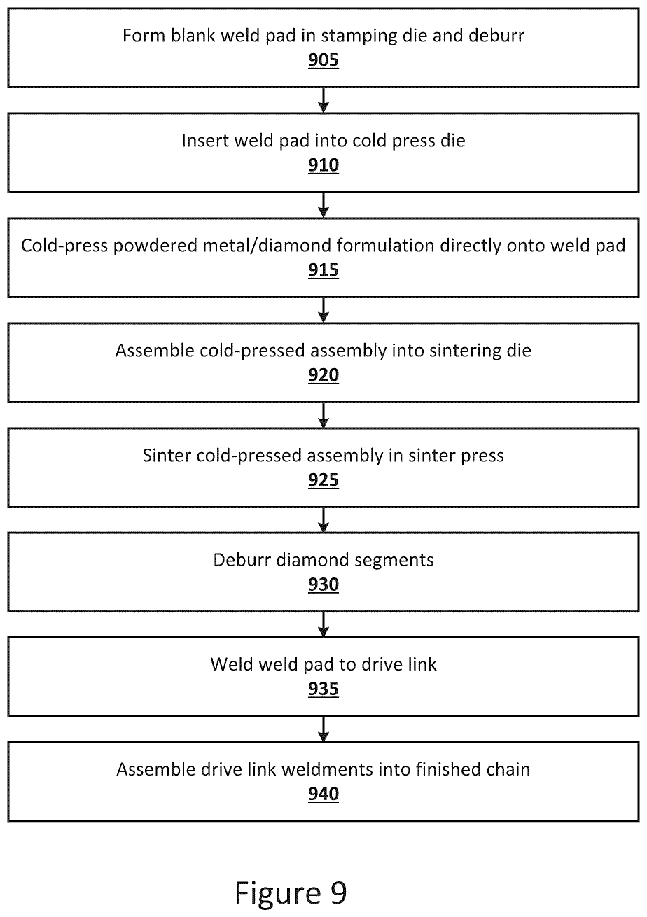

FIG. 9 illustrates an alternative examples technique for manufacturing the chain link 425 of FIG. 4, or some other chain link, in accordance with embodiments herein. The technique may start with element 905, which may be similar to element 805. The weld pad formed at 905 may be inserted, at 910, into a cold press die. Then, at 915, the powdered metal/diamond formulation described above with respect to sintered diamond layer 210 may be cold-pressed directly onto the weld pad. The resultant weld pad and cold-pressed metal/diamond layer assembly may be inserted into a sintering die at 920. Remaining elements 925, 930, 935, and 940 may be respectively similar to elements 820, 825, 830, and 835, and are not reiterated here for the sake of conciseness.

It will be understood that the above-described techniques of FIGS. 8 and 9 are intended as high-level example techniques, and other embodiments may vary. For example, other embodiments may include more or fewer elements, elements arranged in a different order, elements occurring concurrently with one another, etc.

The chain link 425 of FIG. 4 and/or other chain links within the scope of the present disclosure (e.g., chain link 725) can be assembled with other links, rivets, etc. into a cutting chain. Such a cutting chain is with the scope of the present disclosure. For example, the cutting chain may include multiple chain links having diamond layers on weld pads as described herein, for example separated by a pattern of other chain elements. In some embodiments, such a cutting chain includes instances of the drive link 320 without the sintered diamond layer 210 (e.g., having blank instances of the weld pad 100), in addition to one or more of instances of the chain link 425 having the sintered diamond layer 210. Inclusion of links with blank pads can provide consistent chain articulation throughout the chain while reducing the number of diamond layers, thereby providing a desired level of unit loading and otherwise providing preferable cutting performance characteristics.

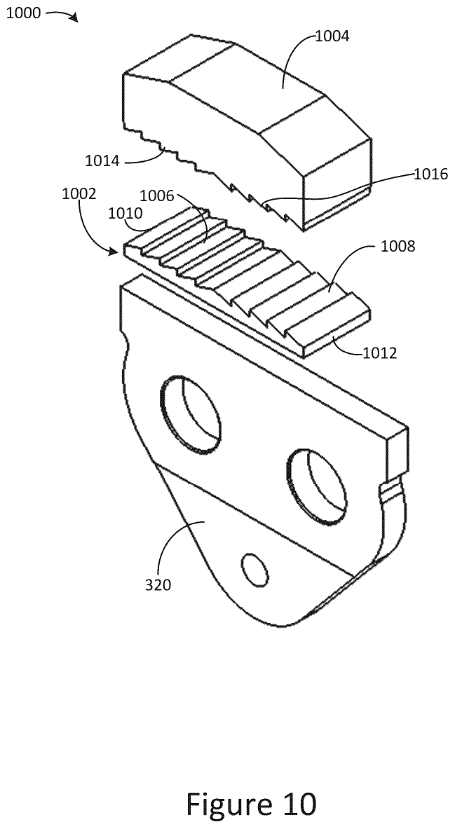

Referring now to FIG. 10, a cutting link 1000 is shown in an exploded view, according to some embodiments. The cutting link 1000 includes the drive link 320, a weld pad 1002 coupled to the drive link 320 (e.g., welded to the drive link 320), and diamond layer 1004 coupled to (e.g., sintered to) the weld pad 1002 such that the weld pad 1002 is between the diamond layer 1004 and the drive link 320.

As shown in FIG. 10, the weld pad 1002 includes a first set of angled steps 1006 and a second set of angled steps 1008 that combine to form a surface of the weld pad 1002 facing the diamond layer 1004. The first set of angled steps 1006 extend laterally across the weld pad 1002 and slope toward a first longitudinal end 1010 of the weld pad 1002. The second set of angled steps 1008 extend laterally across the weld pad 1002 and slope toward a second longitudinal end 1012 of the weld pad 1002 opposite the first longitudinal end 1010. Preferably, the first and second set of angled steps 1006 and 1008 are complementary or substantially complementary to one another.

The diamond layer 1004 is shown as including a third set of angled steps 1014 and a fourth set of angled steps 1016 that combine to form a surface of the diamond layer 1004 facing the weld pad 1002. The third set of angled steps 1014 of the diamond layer 1004 have a shape match a negative space of the first set of angled steps 1006 of the weld pad 1002. The fourth set of angled steps 1016 have a shape matching a negative space of the second set of angled steps 1008 of the weld pad 1002. Accordingly, the third set of angled steps 1014 are preferably complementary and can engage and mate with the first set of angled steps 1006 while the fourth set of angle steps 1016 are complementary and engages and mates with the second set of angled steps 1008, thereby providing mechanical engagement between the weld pad 1002 and the diamond layer 1004. Such mechanical engagement between the weld pad 1002 and the diamond layer 1004 can provide some or all of the advantages described elsewhere herein with respect to mechanical interface, engagement, interaction, etc. between weld pads and diamond layers.

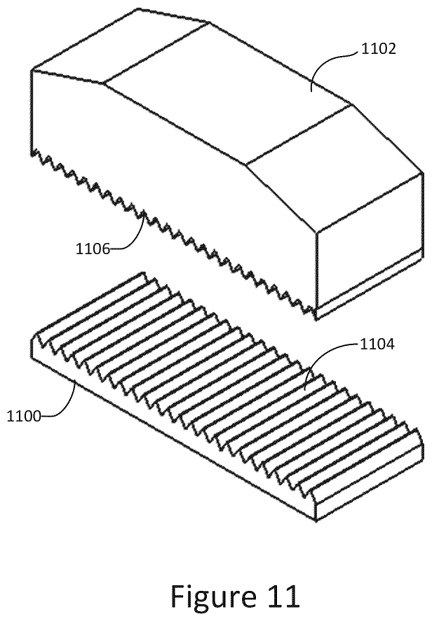

Referring now to FIG. 11, a weld pad 1100 and a diamond layer 1102 are shown in an exploded view, according to some embodiments. The weld pad 1100 can be coupled to (e.g., sintered to) the diamond layer 1102. The weld pad 1100 can be coupled to (e.g., welded to) a link (e.g., drive link 320 as shown and described elsewhere herein) to form a cutting link as according to the teachings herein.

As shown in FIG. 11, the weld pad 1100 includes multiple teeth 1104 that define a surface of the weld pad 1100 facing the diamond layer 1102, with the teeth 1104 being projections extending toward the diamond layer 1102. As shown, the teeth 1104 extend laterally across the weld pad 1100, and may be oriented differently in various embodiments. As shown, approximately 20 teeth 1104 are included (e.g., 24 teeth), while other numbers of teeth 1014 can be included in various embodiments. The diamond layer 1102 is shown as including notches 1106 which define a surface of the diamond layer 1104 facing the weld pad 1100 and are complementary, or shaped to provide negative spaces matching the geometry teeth 1104 such that the teeth 1104 can be received in the notches 1106. Accordingly, when the weld pad 1100 and the diamond layer 1102 are coupled together, the teeth 1104 of the weld pad 1100 are positioned in the notches 1106, thereby providing mechanical engagement between the diamond layer 1102 and the weld pad 1100. In other embodiments and/or in another characterization, the diamond layer 1102 can be described as having teeth received in notches of the weld pad 1100. Such mechanical engagement between the weld pad 1102 and the diamond layer 1104 can provide some or all of the advantages described elsewhere herein with respect to mechanical interface, engagement, interaction, etc. between weld pads and diamond layers.

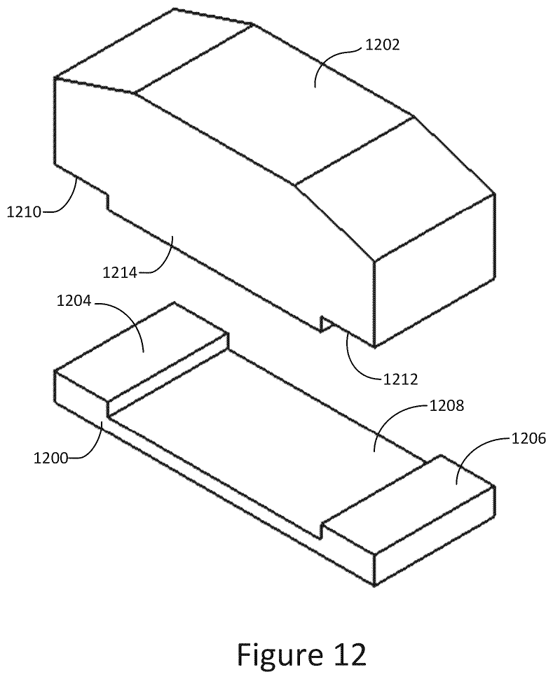

Referring now to FIG. 12, a weld pad 1200 and a diamond layer 1202 are shown in an exploded view, according to some embodiments. The weld pad 1200 can be coupled to (e.g., sintered to) the diamond layer 1202. The weld pad 1200 can be coupled to (e.g., welded to) a link (e.g., drive link 320 as shown and described elsewhere herein) to form a cutting link according to the teachings herein.

As shown in FIG. 12, the weld pad 1200 includes a first block 1204 defining a first longitudinal end of the weld pad 1200, a second block 1206 defining a second, opposite longitudinal end of the weld pad 1200, and a center portion 1208 extending form the first block 1204 to the second block 1206. The first block 1204 and the second block 1206 are thicker than the center portion 1208 of the weld pad 1200 such that the first block 1204 and the second block 1206 extend above the center portion 1208 of the weld pad 1200. The weld pad 1200 is thereby provided with a recess, open volume, negative space etc. facing the diamond layer 1202 and bounded on three sides by the first block 1204, the second block 1206, and the center portion 1208.

Also as shown in FIG. 12, the diamond layer 1202 has a side facing the weld pad 1200 that includes a first surface 1210 arranged to align with the first block 1204, a second surface 1212 arranged to align with the second block 1206, and a center projection 1214 extending from the first surface 1210 to the second surface 1212 and arranged complementary to and align with the center portion 1208 of the weld pad 1200. The center projection 1214 is shaped to be received in and match a shape of the recess, depression, recess, open volume, negative space etc. bounded by the first block 1204, the second block 1206, and the center portion 1208 of the weld pad 1200. Such interconnection provides mechanical engagement between the diamond layer 1202 and the weld pad 1200, which can provide some or all of the advantages described elsewhere herein with respect to mechanical interface, engagement, interaction, etc. between weld pads and diamond layers.

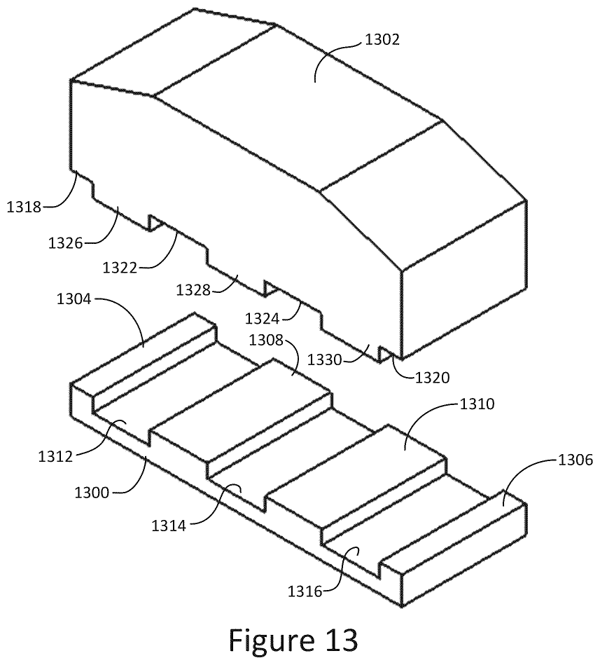

Referring now to FIG. 13, a weld pad 1300 and a diamond layer 1302 are shown in an exploded view, according to some embodiments. The weld pad 1300 can be coupled to (e.g., sintered to) the diamond layer 1302. The weld pad 1300 can be coupled to (e.g., welded to) a link (e.g., drive link 320 as shown and described elsewhere herein) to form a cutting link according to the teachings herein.

As shown in FIG. 13, the weld pad 1300 includes a first block 1304 defining a first longitudinal end of the weld pad 1200, a second block 1306 defining a second, opposite longitudinal end of the weld pad 1200, a third block 1308 positioned between the first block 1304 and the second block, and a fourth block 1310 positioned between the third block 1302 and the second block 1306, with a first lower portion 1312 extending from the first block 1304 to the third block 1306, a second lower portion 1314 extending from the third block 1306 to the fourth block 1310, and a third lower portion 1316 extending from the fourth block 1310 to the second block 1306. The blocks 1304, 1306, 1308, 1310 are thicker than the lower portions 1312, 1314, 1316, such that recesses, open volumes, negative space, etc. are provided at the lower portions 1312, 1314, 1316 between the blocks 1304, 1306, 1308, 1310 and facing the diamond layer 1302.

The diamond layer 1302 includes a bottom side defined by a first surface 1318 shaped complementary to and aligned with the first block 1304, a second surface 1320 shaped complementary to and aligned with the second block 1306, a third surface 1322 shaped complementary to and aligned with the third block 1308, a fourth surface 1324 shaped complementary to and aligned with the forth block 1310, a first projection 1326 positioned between the first surface 1318 and the second surface 1320 and shaped to match the negative space at the first lower portion 1312, a second projection 1328 positioned between the third surface 1322 and the fourth surface 1324 and shaped to match the negative space at the second lower portion 1314, and a third projection 1330 positioned between the fourth surface 1324 and the second surface 1320 and shaped to match the negative space at the third lower portion 1316. The diamond layer 1302 is thereby configured to be received by and mechanically engage with the weld pad 1300, providing some or all of the various advantages of mechanical interconnection between diamond layers and weld pads described herein.

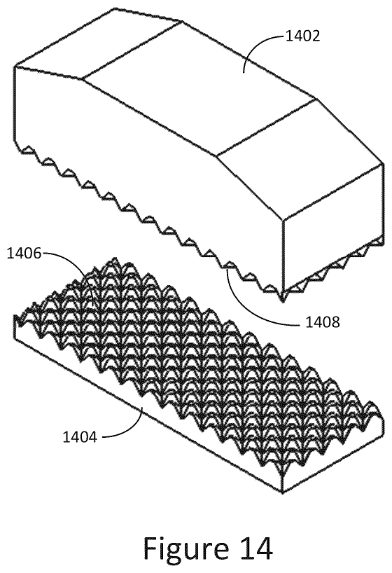

Referring now to FIG. 14, a weld pad 1400 and a diamond layer 1402 are shown in an exploded view, according to some embodiments. The weld pad 1400 can be coupled to (e.g., sintered to) the diamond layer 1402. The weld pad 1400 can be coupled to (e.g., welded to) a link (e.g., drive link 320 as shown and described elsewhere herein) to form a cutting link according to the teachings herein.

As shown in FIG. 14, the weld pad 1400 includes a top surface 1406 facing the diamond layer 1402 and the diamond layer 1402 has bottom surface 1408 facing the weld pad 1400. The top surface 1406 of the weld pad 1400 is textured, for example with a pattern of alternating bumps and divots arranged in rows as shown in FIG. 14. The bottom surface 1408 includes complementary textures, for example with a pattern of divots and bumps arranged in an opposite manner as for the top surface 1406 of the weld pad 1400 such that bumps of top surface 1406 of the weld pad 1404 align with and are received by divots of the bottom surface 1408 of the diamond layer 1402 while bumps of the bottom surface 1408 of the diamond layer 1402 align with and are received by divots of the top surface 1406 of the weld pad 1404. Mechanical engagement between the weld pad 1400 and the diamond layer 1402 is thereby providing, enabling, providing some or all of the various advantages of mechanical interconnection between diamond layers and weld pads described herein.

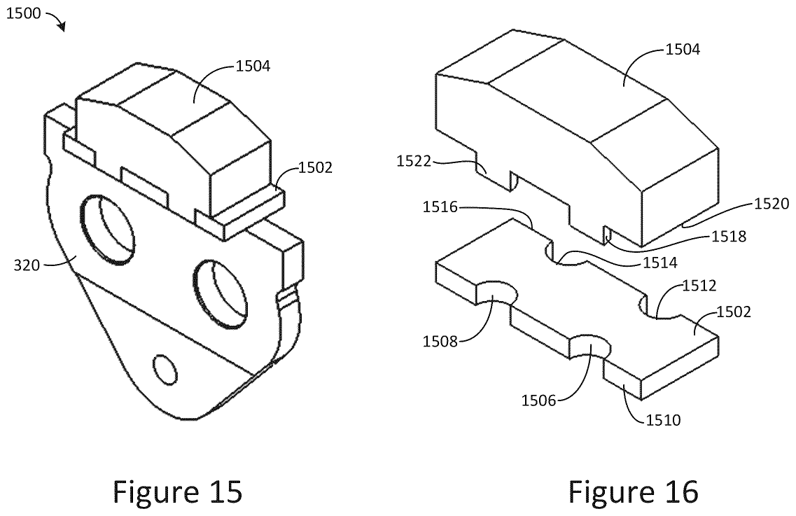

Referring now to FIGS. 15-16, a cutting link 1500 having a weld pad 1502, a diamond layer 1504 coupled to (e.g., sintered to) the weld pad 1502 and a drive link 320 coupled to (e.g., welded to the weld pad 1502) is shown, according to some embodiments. FIG. 15 shows the cutting link 1500 in a perspective view and FIG. 16 shows an exploded view of the weld pad 1502 and the diamond layer 1504.

As shown in FIGS. 15-16, the weld pad 1502 includes a first indentation 1506 and a second indentation 1508 along a first side 1510 of the weld pad 1502 and a third indention 1512 and a fourth indention 1514 along a second side 1516 of the weld pad 1502. The first side 1510 and the second side 1512 of the weld pad 1502 are arranged on opposite sides of the drive link 320 as shown in FIG. 15. As shown in FIGS. 15-15, the indentations 1506, 1508, 1512, 1514 are semicircular, and may have other shapes in other embodiments.

The diamond layer 1504 is shown as including a first projection 1518 shaped complementary to the first indention 1506 (e.g., semicircular cross-section) and extending from a bottom side 1520 of the diamond layer 1504, and a second projection 1522 shaped complementary to the second indentation 1508 (e.g., semicircular cross-section) and extending from the bottom side 1520 of the diamond layer 1504. As shown in FIG. 15, the first projection 1518 is received in the first indentation 1506 and substantially fills the first indentation 1506, while the second projection 1522 is received in the second indentation 1508. The first projection 1518 and the second projection 1522 are also shown as being substantially flush with the first side 1510 of the weld pad 1502. The diamond layer 1504 can also include third and fourth projections similarly configured as the first projection 1518 and the second projection 1522 but received in the third indention 1512 and the forth indentation 1514 of the weld layer 1502. The diamond layer 1504 thereby engages and mechanically interconnects with the weld pad 1502, thereby providing some or all of the various advantages of mechanical interconnection between diamond layers and weld pads described herein.

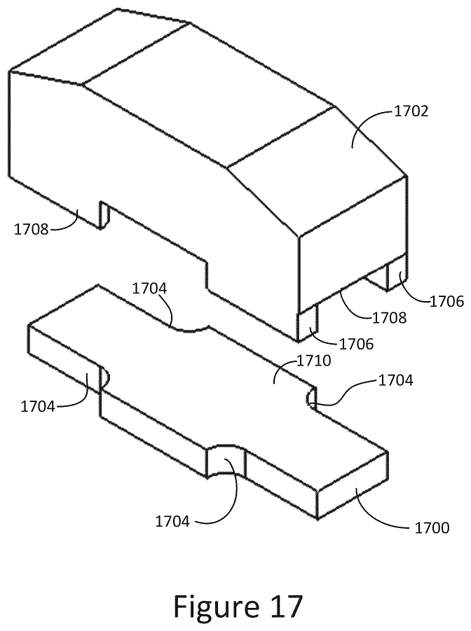

Referring now to FIG. 17, a weld pad 1700 and a diamond layer 1702 are shown in an exploded view, according to some embodiments. The weld pad 1700 can be coupled to (e.g., sintered to) the diamond layer 1702. The weld pad 1700 can be coupled to (e.g., welded to) a link (e.g., drive link 320 as shown and described elsewhere herein) to form a cutting link according to the teachings herein.

The weld pad 1700 is shown as being substantially rectangular in shape but having depressed corners 1704. The depressed corners 1704 provide negative space within a rectangular footprint of the weld pad 1700. The diamond layer 1702 is shown as including projections 1706 from a bottom side 1708 of the diamond layer 1702, with the projections 1706 positioned at corners of the bottom side 1708. The projections 1706 are shaped complementary to the depressed corners 1704 so as to be received by the depressed corners 1704 (e.g., mate with the depressed corners 1704) to complete the rectangular footprint of the weld pad 1700 while the bottom side 1708 contacts a top side 1710 of the weld pad 1700. The diamond layer 1702 thereby engages and mechanically interconnects with the weld pad 1700, thereby providing some or all of the various advantages of mechanical interconnection between diamond layers and weld pads described herein.

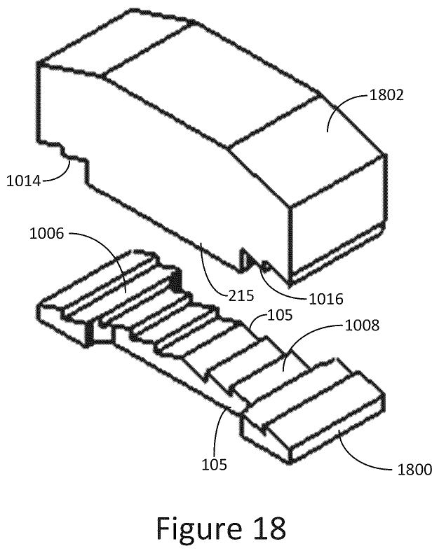

Referring now to FIG. 18, a weld pad 1800 and a diamond layer 1802 are shown in an exploded view, according to some embodiments. The weld pad 1800 can be coupled to (e.g., sintered to) the diamond layer 1802. The weld pad 1800 can be coupled to (e.g., welded to) a link (e.g., drive link 320 as shown and described elsewhere herein) to form a cutting link according to the teachings herein.

The weld pad 1800 is shown as include a first set of angled steps 1006 and second set of angled steps 1008 and the diamond layer 1802 is shown as including a third set of angled steps 1014 and a fourth set of angled steps 1016, as described above with reference to FIG. 10. The weld pad 1800 is further shown as including a recess portion 105 on either lateral side of the weld pad 1800, and the diamond layer 1802 is shown as including protrusions 215 as described above with reference to at least FIGS. 1-5C. Accordingly, as shown in FIG. 18, the weld pad 1800 and the diamond layer 1802 are mechanically engaged by both the combination of the first set of angled steps 1006 and the second set of angled steps 1008 with the third set of angled steps 1014 and the fourth set of angled steps 1016 and the combination of the protrusions 215 and the recess portions 105, thereby providing some or all of the various advantages of mechanical interconnection between diamond layers and weld pads described herein.

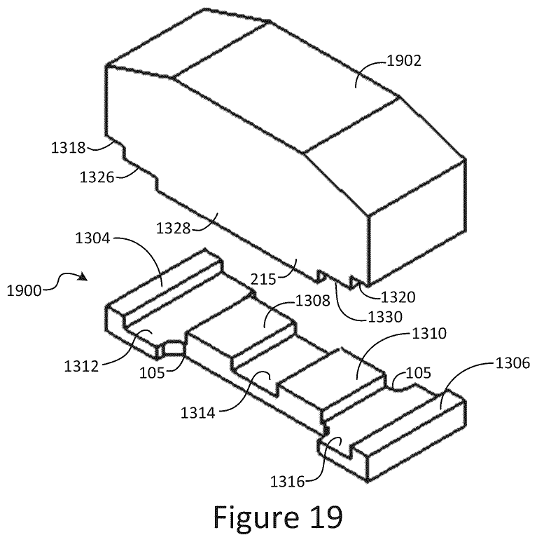

Referring now to FIG. 19, a weld pad 1900 and a diamond layer 1902 are shown in an exploded view, according to some embodiments. The weld pad 1900 can be coupled to (e.g., sintered to) the diamond layer 1902. The weld pad 1900 can be coupled to (e.g., welded to) a link (e.g., drive link 320 as shown and described elsewhere herein) to form a cutting link according to the teachings herein.

As shown in FIG. 19, the weld pad 1900 includes a first block 1306, second block 1304, third block 1308, fourth block 1310, first lower portion 1312, second lower portion 1314, and third lower portion 1316 as described above with reference to FIG. 13. The diamond layer 1902 can include the first surface 1318, second surface 1320, third surface 1322, fourth surface 1324, first projection 1326, second projection 1328, and third projection 1330 described with reference to FIG. 13. The weld pad 1900 and the diamond layer 1902 thus mechanically engage one another in part as described with reference to FIG. 13 above. Further, the weld pad 1900 is shown as including the recesses 105 and the diamond layer 1902 is shown as including diamond layer projections 215 as described with reference to at least FIGS. 1-5C above, which also interface to provide further engagement between the weld pad 1900 and the diamond layer 1902.

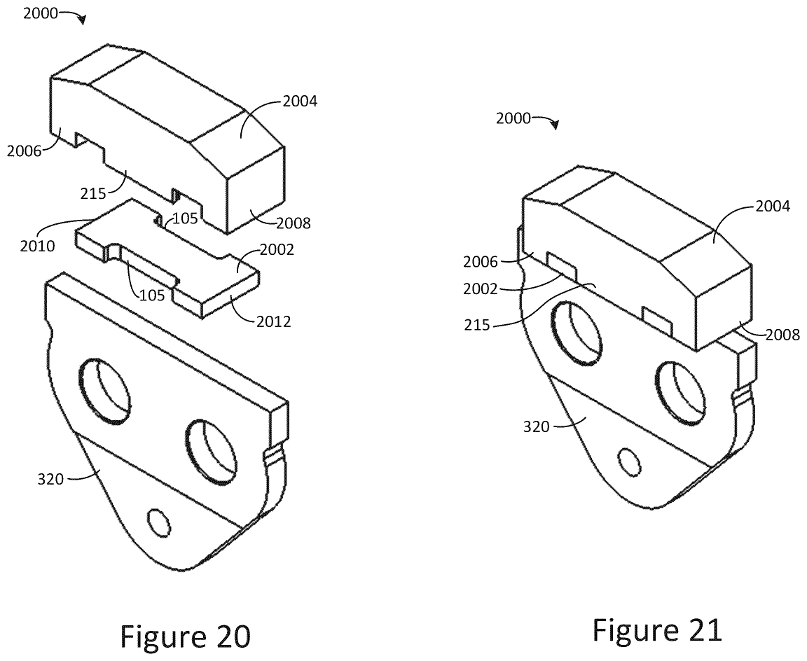

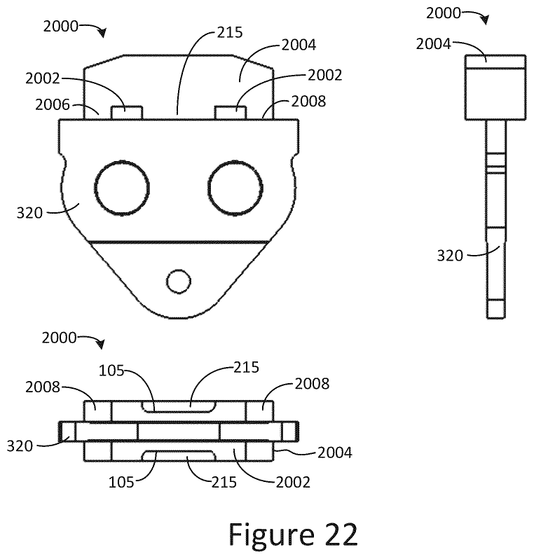

Referring now to FIGS. 20-22, a cutting link 2000 having a weld pad 2002, a diamond layer 2004 coupled to (e.g., sintered to) the weld pad 2002 and a drive link 320 coupled to (e.g., welded to the weld pad 2002) is shown, according to some embodiments. FIG. 20 shows the cutting link 2000 in an exploded perspective view, FIG. 22 shows a non-exploded perspective view of the cutting link 2000, and FIG. 22, shows side, bottom, and end views of the cutting link 2000.

As shown in FIGS. 20-22, the weld pad 2002 includes the recess portions 105 and the diamond layer 2004 includes the diamond layer projections 105 as described with reference to at least FIGS. 1-5C above. The diamond layer 2004 is further shown as including a first end projection 2006 and a second end projection 2008, where the first end projection 2006 and the second end projection extend from a bottom surface of the diamond layer 2004 at opposing ends of the diamond layer 2004. The first end projection 2006 and the second end projection 2006 extend parallel to the diamond layer projections 215, with the diamond layer 2004 sized to be longer than the weld pad 2002 such that the first end projection 2006 is positioned beyond a first end 2010 of the weld pad 2002 and the second end projection 2008 is positioned along a second end 2012 of the weld pad 2002 opposite the first end 2010. Such a configuration can also be described as the diamond layer 2004 having an I-shaped recess on a bottom side of the diamond layer 2004 that provides a negative space matching the shape of the weld pad 2002, such that the weld pad 2002 fits snuggly in the recess of the diamond layer. Accordingly, the diamond layer mechanically engages with the weld pad 2010 at the recess portions 105, the first end 2010, and the second end 2012 of the weld pad 2010, thereby providing some or all of the various advantages of mechanical interconnection between diamond layers and weld pads described herein.

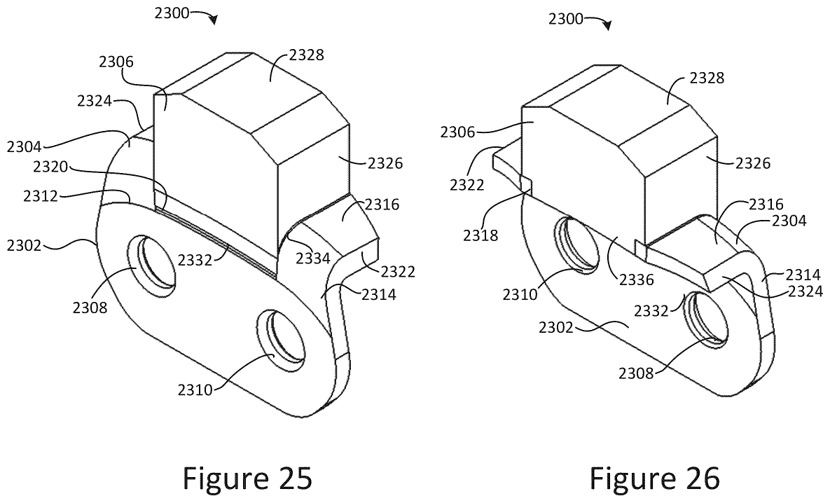

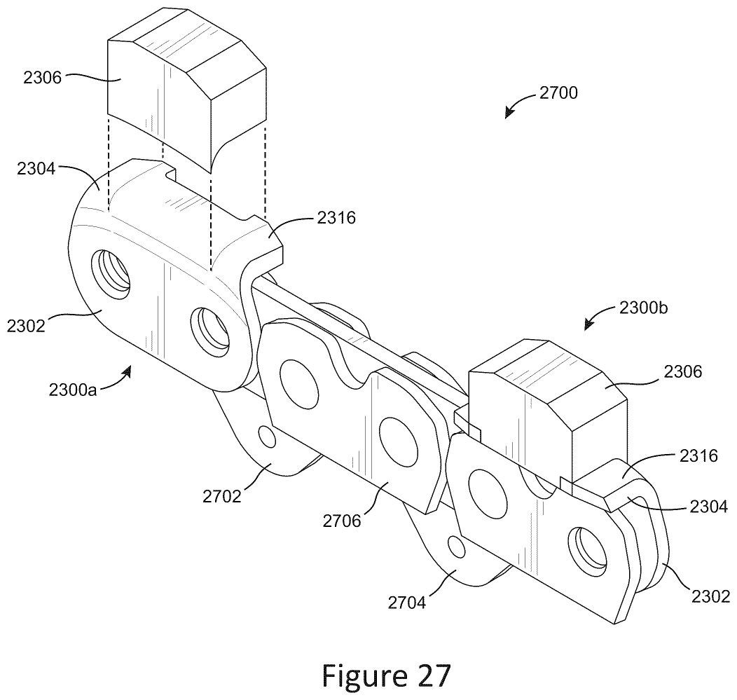

Referring now to FIGS. 23-27, illustrations of a tie strap having a sintered diamond layer and a chain including instances of such a tie strap are shown, according to some embodiments. In particular, FIG. 23 shows an exploded view of a tie strap 2300 in a first orientation, FIG. 24 shows an exploded view of the tie strap 2300 in a second orientation, FIG. 25 shows the tie strap 2300 in the first orientation, FIG. 26 shows the tie strap 2300 in the second orientation, and FIG. 27 shows a cutting chain 2700 including a first instance of the tie strap 2300 assembled into the cutting chain in the first orientation (shown as tie strap 2300a) and a second instance of the tie strap 2300 assembled into the cutting chain 2700 in the second orientation (shown as tie strap 2300b).

The tie strap 2300 is shown as including a tie strap body 2302, an integrated pad 2304 extending from the tie strap body 2302, and a diamond layer 2304 coupled to (e.g., sintered to) the integrated pad 2304. The tic strap body 2302 is substantially planar and is shown as having an oblong, roughly-rectangular shape. The tie strap body 2302 includes a first rivet hole 2308 and a second rivet hole 2310 which are configured to receive rivets connecting the tie strap body 2302 to neighboring links of the cutting chain 2700 (e.g., drive links 2702, 2704 of the cutting chain 2700).

The integrated pad 2304 is shown as being integrally formed with the tie strap body 2302 and extending from an outward side 2312 of the tie strap body 2302 (i.e., in a direction away from a bar of a chain saw and toward the external environment when the cutting chain 2700 is installed for use with a chain saw). As shown, the integrated pad 2304 is bent relative to the tie strap bod 2302 (e.g., in stamping operating during manufacturing) so as to have a vertical portion 2314 substantially parallel to the tie strap body 2302 and a horizontal portion 2316 at approximately a right angle relative to the tie strap body 2302 and the vertical portion 2314, with the vertical portion 2314 extending from the tie strap body 2302 to the horizontal portion 2316.

The horizontal portion 2316 provides an upward- (e.g., outward-) facing surface substantially orthogonal to the tie strap body 2302. The horizontal portion 2316 includes a recess 2318 on a distal side thereof (i.e., a side furthest from the tie strap body 2302). The integrated pad 2304 is also shown as providing a notch 2320 along at least a portion of the outward side 2312 of the tie strap body 2302. As shown in FIGS. 23-27, the horizontal portion 2316 is tapered towards longitudinal ends of the tie strap 2300 so as to be narrower at a first end 2322 and a second end 2324 as compared to other areas of the horizontal portion 2316.

The diamond layer 2306 is shown as including a body (e.g., block, prism, etc.) 2326 having a crowned top 2328 (e.g., tapered at either longitudinal end of the diamond layer 2306) and a curved bottom surface 2330 opposite the crowned top 2328 and contoured to be complementary to (e.g., match, mate with, etc.) the integrated pad 2304 and the curvature, bending, corner, etc. between the vertical portion 2314 and the horizontal portion 2316 of the integrated pad 2304. The curved bottom surface 2330 terminates at an edge 2332 and includes, opposite the edge, a projection 2334. The edge 2332 is received by the notch 2320 defined by the integrated pad 2304 and the projection 2334 is received in the recess 2318 of the integrated pad 2304. The diamond layer 2306 can thereby mate against (abut, etc.) the integrated pad 2304 and mechanically engage with the integrated pad 2304.

The diamond layer 2306 can be sintered to the integrated pad 2304, for example as described above, and for example including various materials, material properties, etc. of the diamond layers and weld pads described above. The unitary structure of the tie strap body 2302 and the integrated pad 2304 (e.g., formed via stamping a single piece of metal) together with structures as described above providing mechanical interconnection between the diamond layer 2306 and the integrated pad 2304 and teachings herein relating to sintering, etc., thereby enable the tie strap 2300 to act as a diamond cutter having a high amount of durability and other advantageous performance characteristics as contemplated herein.

As shown in FIG. 27, a cutting chain 2700 can include multiple instances of the tie strap 2300, for example arranged in alternating orientations. The cutting chain 2700 is shown as including a first tie strap 2300a in a first orientation (with the horizontal portion 2316 pointing to the right from the viewpoint of FIG. 27) (shown in an exploded view) and a second tie strap 2300b in a second orientation, rotated 180 degrees relative to the first orientation (with the horizontal portion 2316 pointing to the left from the viewpoint of FIG. 27). The first tie strap 2300a is connected to a first drive link 2702 (e.g., by a rivet) and the second tie strap 2300b is connected to a second drive link 2704 (e.g., by a rivet), with the first drive link 2702 connected to the second drive link 2704 by an intermediary tie strap 2706. The cutting chain 2700 can be extended from the segment form by repeating the pattern of links, straps, rivets, etc. shown in FIG. 27 in either or both directions (e.g., to form a loop). Alternating the orientations of the tie straps 2300a,b as shown in FIG. 27 can balance cutting performance (e.g., forces generated during cutting), provide more even wear patterns, etc. thereby providing advantages over other cutting chains.

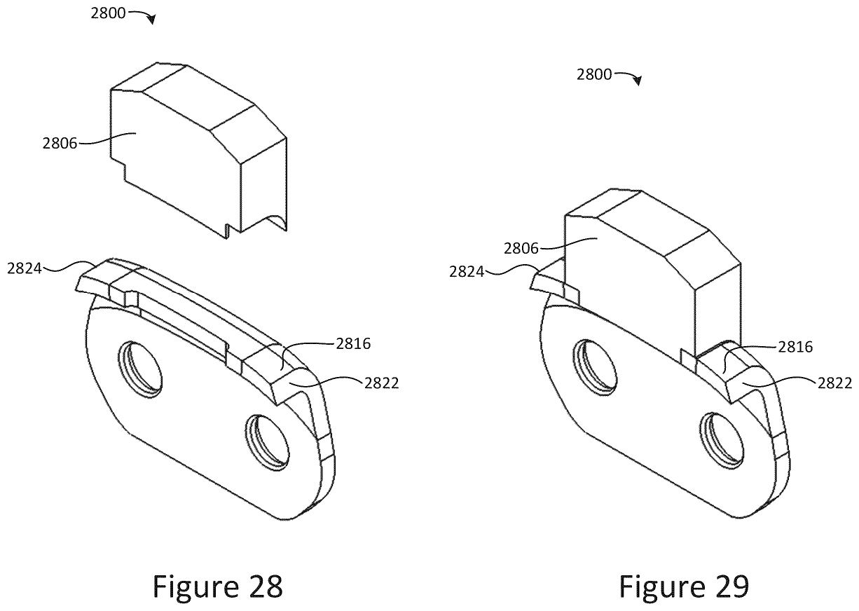

Referring now to FIGS. 28-31, illustrations of another tie strap with a diamond layer (shown as tie strap 2800) included in a cutting chain (shown as cutting chain 3000) are shown, according to some embodiments. The tie strap 2800 and the cutting chain 3000 are configured substantially as described for the tie strap 2300 and cutting chain 2700 other than the differences outlined in the following passages.

For the tie strap 2300 of FIGS. 23-27, the horizontal portion 2316 is tapered as described above so as to be narrower at longitudinal ends 2322, 2324 thereof and widening through a remainder of the horizontal portion 2316 to the recess portion 2318 where the diamond layer 2306 is received. The diamond layer 2306 is thereby wider than the longitudinal ends 2322, 2324 of the horizontal portion 2316 of the integrated pad 2304.

In contrast, the tie strap 2800 of FIGS. 28-31 includes a horizontal portion 2816 having a first longitudinal end 2822 and a second longitudinal end 2824 which are wider than a remainder of the horizontal portion 2816. The horizontal portion 2816 thereby narrows to where the diamond layer 2806 is received, and the diamond layer 2806 is no wider than (e.g., is narrower than) the first longitudinal end 2822 and the second longitudinal end 2824 of the horizontal portion 2816.

Such differences between the tie strap 2300 and the tie strap 2800 enable different cutting characteristics of the cutting chain 2700 and the cutting chain 3000, for example as may be suitable for different applications (e.g., different material or objects being cut), different saws, different saw configurations, and/or different user preferences. In some embodiments, a cutting chain is provided with instances of both the tie strap 2300 and the tie strap 2800, thereby providing diamond cutters of different widths along the same cutting chain. In various embodiments, a cutting chain can include any combination, pattern, order, etc. of the tie straps, cutting links, drive links, etc. described herein and/or shown in the drawings, and all such combinations are within the scope of the present disclosure.

A power tool (e.g., chain saw, concrete cutting saw) including a cutting chain having one or more links according to the teachings herein is also within the scope of the present disclosure.

Some non-limiting examples of various embodiments are provided below.

Example 1 includes a chain link of a chain, wherein the chain link includes: a weld pad with a recess portion at a periphery of the weld pad, wherein the recess portion extends through the thickness of the weld pad; and a sintered diamond layer that is coupled with the weld pad, wherein the sintered diamond layer includes a protrusion that is disposed within the recess portion of the weld pad.

Example 2 includes the chain link of example 1, or some other example herein, wherein the recess portion is a first recess portion disposed at a first periphery of the weld pad, and wherein the weld pad further includes a second recess portion at a second periphery of the weld pad opposite the first periphery; and the protrusion is a first protrusion, and the sintered diamond layer includes a second protrusion that is disposed in the second recess portion of the weld pad.

Example 3A includes the chain link of example 1, or some other example herein, wherein the sintered diamond layer includes diamond and at least one of: cobalt, nickel, iron, zinc, copper, tin, phosphorous, aluminum, manganese, chromium, and alloys thereof. Example 3B includes the chain link of example 1, or some other example herein, wherein the sintered diamond layer consists of materials other than cobalt.

Example 4 includes the chain link of example 1, or some other example herein, wherein the sintered diamond layer is sintered to the weld pad.

Example 5 includes the chain link of example 1, or some other example herein, wherein the chain link further comprises a drive link that is welded to the weld pad.

Example 6 includes the chain link of example 1, or some other example herein, wherein the weld pad has a height as measured along an axis that is perpendicular to a face of the weld pad to which the sintered diamond layer is coupled, and wherein the protrusion does not extend beyond a periphery of the weld pad.

Example 7 includes the chain link of example 1, or some other example herein, wherein the weld pad has a length as measured in a direction parallel to a direction of movement of the chain link when used in a cutting implement, and a width as measured in a direction perpendicular to the length, and wherein the sintered diamond layer does not extend beyond the length or the width of the weld pad.

Example 8 includes the chain link of example 1, or some other example herein, wherein the weld pad includes low-carbon steel.

Example 9 includes the chain link of example 8, or some other example herein, wherein the low-carbon steel is American Iron and Steel Institute (AISI) 1010 or equivalent.

Example 10 includes a diamond segment comprising: a steel weld pad that is configured to be coupled with a drive link of a cutting chain; and a diamond layer that is coupled with the steel weld pad such that the diamond layer extends along a height of the steel weld pad at a peripheral portion of the steel weld pad.

Example 11 includes the diamond segment of example 10, or some other example herein, wherein the steel weld pad is configured to be coupled with the drive link through a laser welding process.

Example 12 includes the diamond segment of example 10, or some other example herein, wherein the steel weld pad includes low-carbon steel.

Example 13 includes the diamond segment of example 12, or some other example herein, wherein the low-carbon steel is American Iron and Steel Institute (AISI) 1010 or equivalent.

Example 14 includes the diamond segment of example 10, or some other example herein, wherein the diamond layer is a sintered diamond layer.

Example 15 includes the diamond segment of example 14, or some other example herein, wherein the sintered diamond layer includes diamond and at least one of: cobalt, nickel, iron, zinc, copper, tin, phosphorous, aluminum, manganese, chromium, and alloys thereof.

Example 16 includes the diamond segment of example 14, or some other example herein, wherein the sintered diamond layer is sintered to the steel weld pad.

Example 17 includes the diamond segment of example 14, or some other example herein, wherein the steel weld pad includes a recess portion that extends along a height of the steel weld pad as measured in an axis perpendicular to a cutting plane of the diamond segment, and the sintered diamond layer includes a protrusion positioned in the recess portion.

Example 18 includes the diamond segment of example 14, or some other example herein, wherein the diamond layer is brazed to the steel weld pad.

Example 19 includes the diamond segment of example 18, or some other example herein, wherein the diamond layer includes a coating that is based on diamond and a nickel-alloy.

Example 20 includes the diamond segment of example 18, or some other example herein, wherein the diamond layer encapsulates the steel weld pad such that the diamond layer covers a cutting face of the steel weld pad and a periphery of the steel weld pad.

The examples herein also including a cutting chain including the chain link of any of examples above or in the in the claims and a chain saw including the cutting chain that includes one or more links in accordance with the examples above or the features claimed.

Although certain embodiments have been illustrated and described herein for purposes of description, this application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second, or third) for identified elements are used to distinguish between the elements, and do not indicate or imply a required or limited number of such elements, nor do they indicate a particular position or order of such elements unless otherwise specifically stated.

What is claimed is:

1. A chain link for a chain, comprising:
a weld pad with a recess portion at a periphery of the weld pad, wherein the recess portion extends through a thickness of the weld pad; and
a sintered diamond layer coupled to the weld pad, wherein the sintered diamond layer comprises a protrusion disposed in the recess portion of the weld pad.

2. The chain link of claim 1, wherein the recess portion is a first recess portion disposed at a first periphery of the weld pad, and wherein the weld pad further comprises a second recess portion at a second periphery of the weld pad opposite the first periphery; and
the protrusion is a first protrusion, and the sintered diamond layer includes a second protrusion disposed in the second recess portion of the weld pad.

3. The chain link of claim 1, wherein the sintered diamond layer includes diamond and at least one of: cobalt, nickel, iron, zinc, copper, tin, phosphorous, aluminum, manganese, chromium, and alloys thereof.

4. The chain link of claim 1, wherein the sintered diamond layer comprises diamond and a matrix material other than cobalt.

5. The chain link of claim 1, wherein the sintered diamond layer is sintered to the weld pad.

6. The chain link of claim 1, wherein the chain link further comprises a drive link that is welded to the weld pad.

7. The chain link of claim 1, wherein the weld pad has a height as measured along an axis perpendicular to a face of the weld pad to which the sintered diamond layer is coupled, and wherein the protrusion does not extend beyond the periphery of the weld pad.

8. The chain link of claim 1, wherein the weld pad has a length as measured in a direction parallel to a direction of movement of the chain link when used in a cutting implement, and a width as measured in a direction perpendicular to the length, and wherein the sintered diamond layer does not extend beyond the length or the width of the weld pad.

9. The chain link of claim 1, wherein the weld pad comprises low-carbon steel being American Iron and Steel Institute (AISI) 1010 or equivalent.

10. A diamond segment comprising:
a steel weld pad configured to be coupled with a drive link of a cutting chain; and
a diamond layer coupled with the steel weld pad such that the diamond layer extends along a height of the steel weld pad at a peripheral portion of the steel weld pad.

11. The diamond segment of claim 10, wherein the steel weld pad is configured to be coupled with the drive link through a laser welding process.

12. The diamond segment of claim 10, wherein the steel weld pad comprises low-carbon steel.

13. The diamond segment of claim 10, wherein the diamond layer is a sintered diamond layer.

14. The diamond segment of claim 13, wherein the sintered diamond layer comprises diamond and at least one of: cobalt, nickel, iron, zinc, copper, tin, phosphorous, aluminum, manganese, chromium, and alloys thereof.

15. The diamond segment of claim 13, wherein the sintered diamond layer is sintered to the steel weld pad.

16. The diamond segment of claim 13, wherein the steel weld pad includes a recess portion that extends along the height of the steel weld pad as measured in a direction perpendicular to a cutting plane of the diamond segment, and the sintered diamond layer includes a protrusion positioned in the recess portion.

17. The diamond segment of claim 10, wherein the diamond layer is brazed to the steel weld pad.

18. The diamond segment of claim 10, wherein the diamond layer includes a coating that is based on diamond and a nickel-alloy.

19. The diamond segment of claim 10, wherein the diamond layer encapsulates the steel weld pad such that the diamond layer covers a cutting face of the steel weld pad and a periphery of the steel weld pad.

20. A cutting link for a cutting chain, the cutting link comprising:
a weld pad; and
a sintered diamond layer both mechanically interfaced with the weld pad and chemically bonded to the weld pad.

21. The cutting link of claim 20, wherein a recess of the weld pad or the sintered diamond layer receives a projection of the other of the weld pad or the sintered diamond layer.

22. The cutting link of claim 21, the cutting link comprising a drive link or tie strap comprising the weld pad as an integrated pad.
